(19) United States
(12) Patent Application Publication
(10) Pub. No.: US 2016/0299381 A1
(43) Pub. Date: Oct. 13, 2016

(54) LIQUID CRYSTAL DISPLAY PANEL AND LIQUID CRYSTAL DISPLAY DEVICE

(71) Applicant: AU Optronics Corp., Hsin-Chu (TW)

(72) Inventors: Ssu-Hui Lu, Hsin-Chu (TW); Ming-Hsien Lee, Hsin-Chu (TW)

(21) Appl. No.: 14/880,292

(22) Filed: Oct. 12, 2015

(30) Foreign Application Priority Data
Apr. 13, 2015 (TW) 104111802

(51) Int. Cl. G02F 1/1335; G02F 1/1362; G02F 1/139; G02F 1/1368; G02F 1/1343; G02F 1/1339

(52) U.S. Cl. CPC G02F 1/133555; G02F 1/13439; G02F 1/134336; G02F 1/1339; G02F 1/1393; G02F 1/1368; G02F 1/13624; G02F 1/133514; G02F 1/133602; G02F 2001/134345; G02F 2001/134372; G02F 2001/133626

(57) ABSTRACT

A liquid crystal display panel includes a first substrate, a second substrate, at least one liquid crystal layer, a first pixel array and a second pixel array. The liquid crystal layer is interposed between the first substrate and the second substrate. The first pixel array is disposed in a first display region of the first substrate, where the first pixel array includes a plurality of first transmissive sub-pixels arranged in columns and rows and disposed adjacent to each other. The second pixel array is disposed in a second display region of the first substrate, and the second pixel array includes a plurality of reflective sub-pixels arranged in columns and rows.

### BACKGROUND OF THE DISCLOSURE

1. Field of the Disclosure

The present disclosure is related to a liquid crystal display (LCD) panel and an LCD device, and more particularly, to an LCD display panel and an LCD device in which a part of the display region is a transmissive display region and another part of the display region is a reflective display region or a transflective display region.

2. Description of the Prior Art

Liquid crystal display (LCD) panel is commonly applied to various electronic products such as flat-screen TVs, tablet PCs and smart mobile phones because of its capability of displaying images with good quality. LCD panels could be broadly classified into transmissive LCD panels and reflective LCD panels. In general, a transmissive LCD panel requires backlight provided by a backlight module to display images, while a reflective LCD panel uses a reflector to reflect ambient light to display images.

With the backlight module, the transmissive LCD panel can be used under low ambient light or no ambient light condition. The backlight module increases power consumption, and thus the transmissive LCD panel cannot operate for a long time. The reflective LCD panel can be operate without backlight module, so that it has the advantages such as low power consumption, thinner thickness and lower weight. However, the reflective LCD panel is not able to operate under low ambient light or no ambient light condition. For electronic products, especially mobile electronic product and wearable electronic product, there will be some limitations in use whether a transmissive LCD panel or a reflective LCD panel is selected as its screen.

### SUMMARY OF THE DISCLOSURE

In one aspect, a display panel in which a part of the display region is a transmissive display region and another part of the display region is a reflective display region or a transflective display region is provided. The backlight module may be turned off in a bright environment to use only the reflective display region to display images so as to save power consumption. The backlight module may be turned on in a dark environment to use the transmissive region to display images.

According to an exemplary embodiment, a display panel is provided. The display panel includes a first substrate, a second substrate, at least one liquid crystal layer, a first pixel array and a second pixel array. The liquid crystal layer is interposed between the first substrate and the second substrate. The first pixel array is disposed in a first display region of the first substrate, where the first pixel array includes a plurality of first transmissive sub-pixels arranged in columns and rows disposed adjacent to each other. The second pixel array is disposed in a second display region of the first substrate, and the second pixel array includes a plurality of reflective sub-pixels arranged in columns and rows.

In another embodiment, an LCD device is provided. The LCD device includes the aforementioned LCD panel and a backlight module disposed under the LCD panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top view diagram illustrating an LCD panel according to a first embodiment of the present disclosure.

FIG. 2 is a cross-sectional view diagram of the LCD panel taken along line A-A′ of FIG. 1.

FIG. 3 is a partially enlarged top view diagram illustrating the LCD panel of FIG. 1.

FIG. 4 is a partially enlarged cross-sectional view diagram illustrating the LCD panel according to the first embodiment of the present disclosure.

FIG. 5 is a partially enlarged cross-sectional view schematic diagram illustrating an LCD panel according to an alternative embodiment of the first embodiment of the present disclosure.

FIG. 6 is a partially enlarged cross-sectional view diagram illustrating an LCD panel according to a second embodiment of the present disclosure.

FIG. 7 is a top view diagram illustrating an LCD panel according to a third embodiment of the present disclosure.

FIG. 8 is a cross-sectional view diagram of the LCD panel taken along line B-B′ of FIG. 7.

FIG. 9 is a top view diagram illustrating an LCD panel according to a fourth embodiment of the present disclosure.

FIG. 10 is a cross-sectional view diagram of the LCD panel taken along line C-C′ of FIG. 9.

FIG. 11 is a partially enlarged top view diagram illustrating the LCD panel of FIG. 9.

FIG. 12 is a partially enlarged cross-sectional view diagram illustrating the LCD panel according to the fourth embodiment of the present disclosure.

FIG. 13 is a partially enlarged top view diagram illustrating an LCD panel according to a fifth embodiment of the present disclosure.

FIG. 14 is a schematic diagram illustrating an LCD device according to an embodiment of the present disclosure.

FIG. 15 is a schematic diagram illustrating an LCD device according to another embodiment of the present disclosure.

### DETAILED DESCRIPTION

To provide a better understanding of the disclosure to the skilled users in the technology of the present disclosure, exemplary embodiments will be detailed as follows. The exemplary embodiments of the present disclosure are illustrated in the accompanying drawings with numbered elements to elaborate the contents and effects to be achieved.

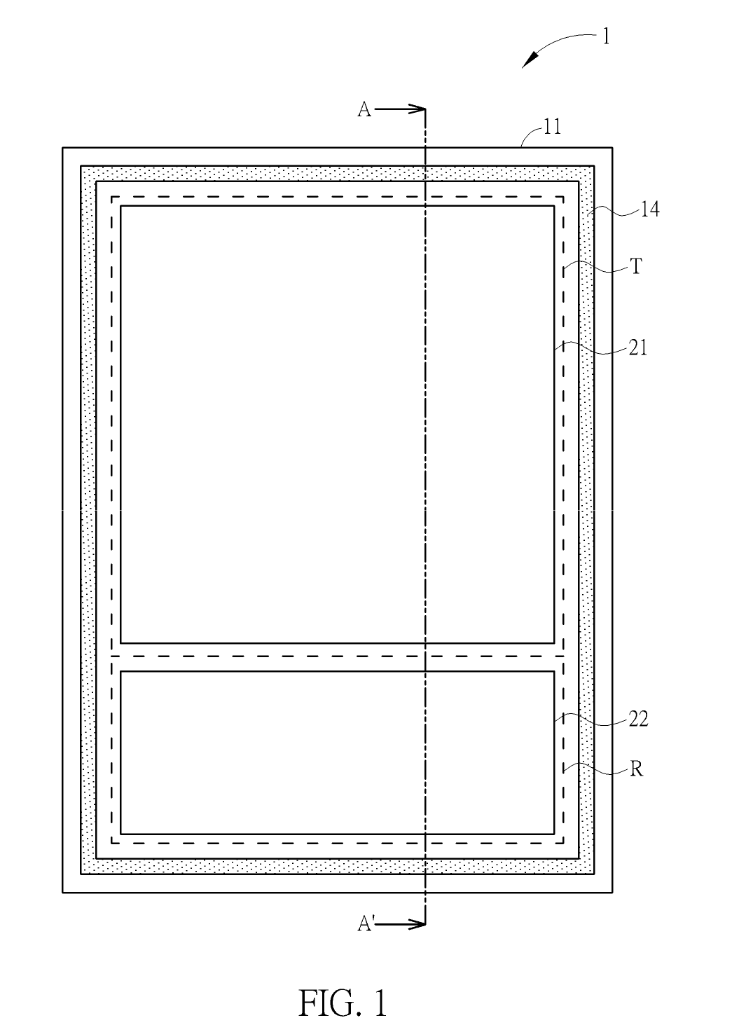

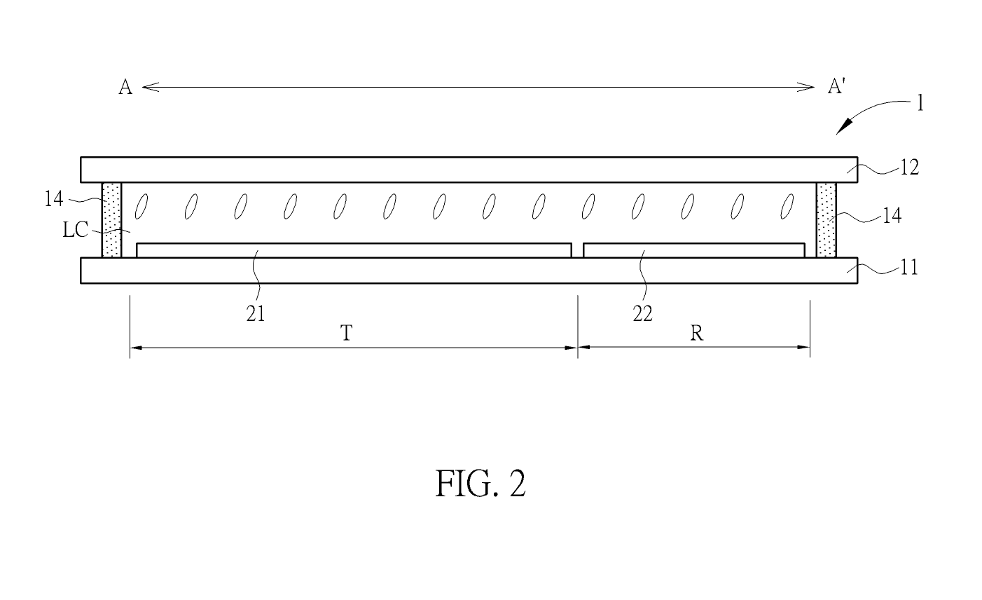

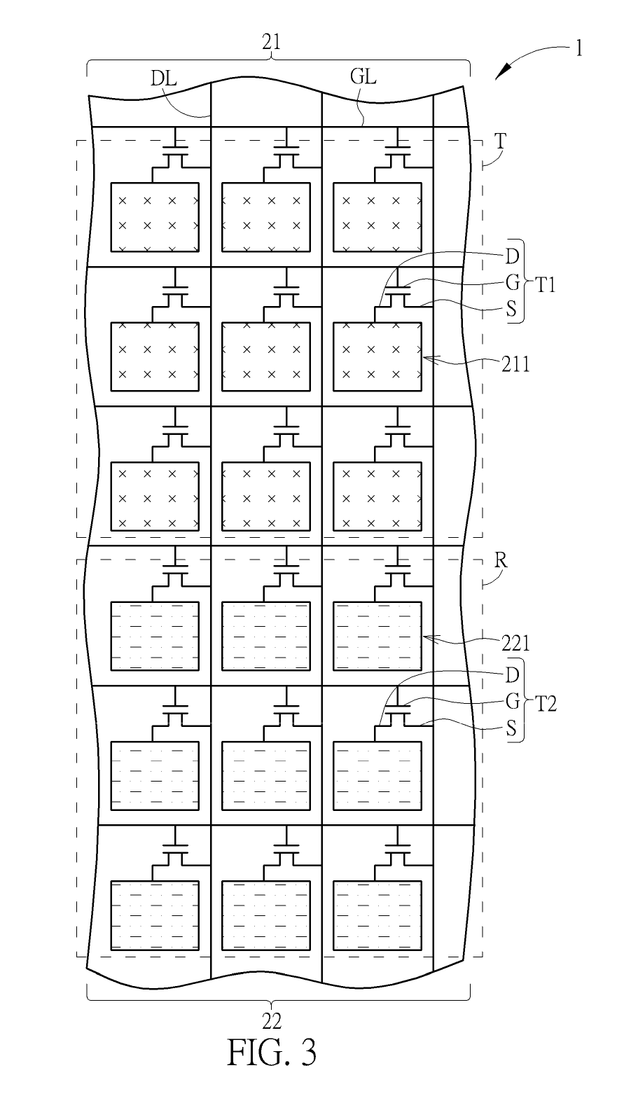

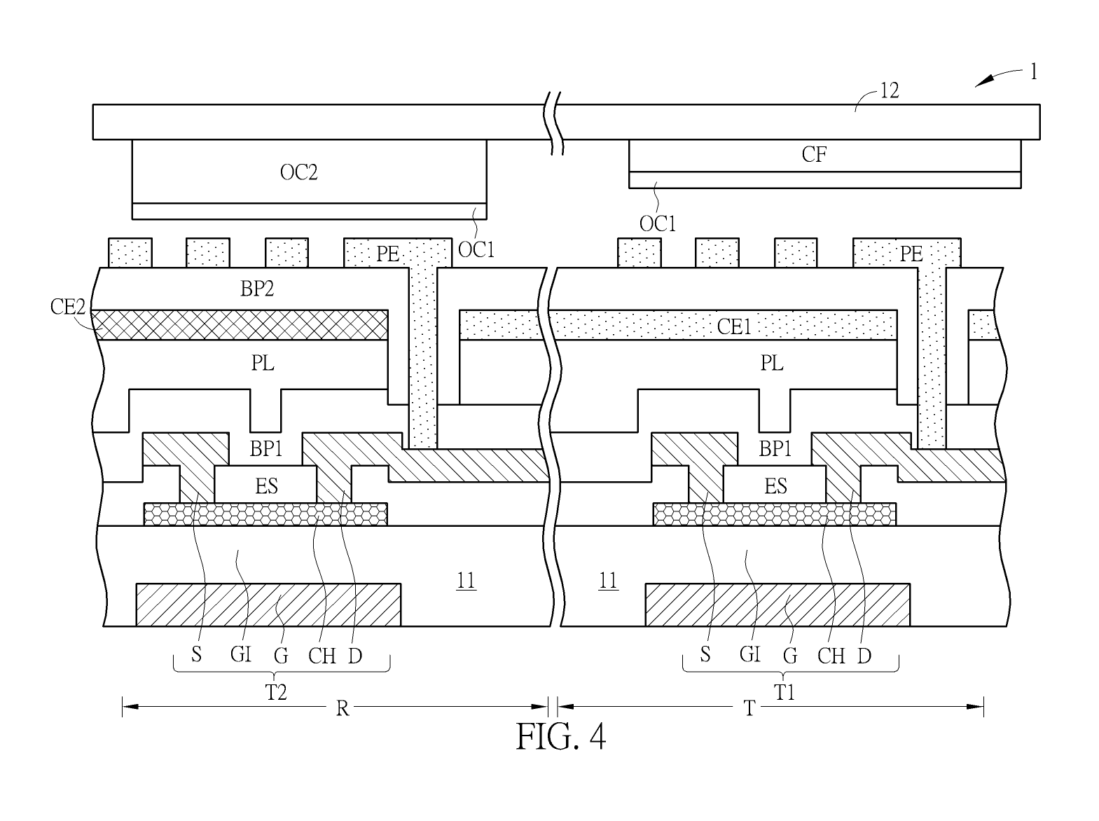

Referring to FIGS. 1-4, FIG. 1-4 are schematic diagrams illustrating an LCD panel according to a first embodiment of the present disclosure, wherein FIG. 1 is a top view diagram illustrating an LCD panel, FIG. 2 is a cross-sectional view diagram of the LCD panel taken along line A-A′ of FIG. 1, FIG. 3 is a partially enlarged top view diagram illustrating the LCD panel, and FIG. 4 is a partially enlarged cross-sectional view diagram illustrating the LCD panel. It is appreciated that some components are not drawn in the diagrams for highlighting the features of the LCD panel. As shown in FIG. 1 and FIG. 2, the LCD panel 1 of this embodiment includes a first substrate 11, a second substrate 12, a liquid crystal layer LC, a first pixel array 21 and a second pixel array 22. The first substrate 11 and the second substrate 12 are disposed opposite to each other, and the first substrate 11 and the second substrate 12 may be a transparent substrate, respectively, and which may be a rigid substrate or a flexible substrate such as a glass-type substrate, a quartz substrate or a plastic substrate, but not limited thereto. The liquid crystal layer LC is interposed between the first substrate 11 and the second substrate 12, and the liquid crystal layer LC may include nematic liquid crystal layer, which includes a plurality of nematic liquid crystal molecules, but not limited thereto and may be other types of liquid crystal layer. The first substrate 11 has a first display region T and a second display region R, wherein the first display region T and the second display region R are disposed adjacent to each other, e.g. the first display region T and the second display region R may be arranged side-by-side in the latitudinal direction or longitudinal direction, or in another configuration. The first pixel array 21 is disposed in the first display region T of the first substrate 11, in which the first pixel array 21 is a transmissive pixel array. The second pixel array 22 is disposed in the second display region R of the first substrate 11, in which the second pixel array 22 is a reflective pixel array. In addition, the liquid crystal display panel 1 may further include a sealant 14 disposed between the first substrate 11 and the second substrate and surrounding the first display region T and the second display region R.

As shown in FIG. 3, the first pixel array 21 includes a plurality of first transmissive sub-pixels 211 arranged in columns and rows, and the plurality of first transmissive sub-pixels 211 are disposed adjacent to each other, i.e. all of the sub-pixels in the first display region T are the first transmissive sub-pixels 211, and no reflective sub-pixels are located between the first transmissive sub-pixels 211. That is, the first display region T is a transmissive display region. The second pixel array 22 is disposed in the second display region R of the first substrate 11, in which the second pixel array 22 includes a plurality of reflective sub-pixel 221 arranged in columns and rows, and the plurality of reflective sub-pixel 221 are also disposed adjacent to each other, i.e. all of the sub-pixels in the second display region R are the reflective sub-pixels 221, and no transmissive sub-pixels are located between the reflective sub-pixels 221. That is, the second display region R is a reflective display region. In addition, as shown in FIG. 3, in the present embodiment, a portion of the first transmissive sub-pixels 211 and a portion of the reflective sub-pixels 221 located in the same column jointly use the same signal line, and the signal line is, for example, a data line DL, but not limited thereto. In an alternative embodiment, the portion of the first transmissive sub-pixels 211 and the portion of the reflective sub-pixels 221 located in the same column or row may use the same gate line GL or the same data line DL, but not limited thereto.

As shown in FIG. 4, each of the first transmissive sub-pixels 211 in the first display region T includes at least one first thin film transistor (TFT) device T1, and each of the reflective sub-pixels 221 in the second display region R includes at least one second TFT device T2. In the present embodiment, the first TFT devices T1 and the second TFT devices T2 are bottom gate type TFT devices. Each of the first TFT devices T1 and each of the second TFT devices T2 include a gate electrode G, a gate insulating layer GI, a semiconductor channel layer CH, a dielectric layer ES, a source electrode S, a drain electrode D, a first protective layer BP1 and a planarization layer PL. The first TFT devices T1 of the first transmissive sub-pixels 211 and the second TFT devices T2 of the reflective sub-pixels 221 may be formed by the same process. For example, the gate electrode G of the first TFT devices T1 and the gate electrode G of the second TFT devices T2 may be the same patterned conductive layer such as a metal layer or an alloy layer, and the material of the gate electrodes G may include, e.g. Al (aluminum), Pt (platinum), Ag (silver), Ti (titanium), Mo (molybdenum), Zn (zinc), Sn (tin), or other metals or alloys, but not limited thereto. The source electrodes S and the drain electrodes D of the first TFT devices T1 and the second TFT devices T2 may be the same patterned conductive layer such as a metal layer or an alloy layer, and the material of the source electrodes S and the drain electrodes D may be the same material as or different materials from the gate electrode G. The semiconductor channel layers CH of the first TFT devices T1 and the second TFT devices T2 may be the same patterned semiconductor layer, which may be a single-layered or a multi-layered structure. The material of the semiconductor channel layer CH may include silicon (e.g. amorphous silicon, polycrystalline silicon, monocrystalline silicon, microcrystalline silicon, nano-crystal silicon), oxide semiconductor material (e.g. indium gallium zinc oxide (IGZO), indium gallium (IGO), indium zinc oxide (IZO), indium tin oxide (ITO), titanium oxide (TiO), zinc oxide (ZnO), indium oxide (InO) or gallium oxide (gallium oxide, GaO)), organic semiconductor material, or other suitable semiconductor materials. The gate insulating layer GI, the first protective layer BP1 and the planarization layer PL may be a single-layered or a multi-layered structure, respectively, and the material of the gate insulating layer GI, the first protective layer BP1 and the planarization layer PL may include inorganic insulating material (e.g. silicon oxide, silicon nitride, silicon nitride oxide, or other suitable insulating material), organic insulating material (e.g. colorless/colored resist, polyimide, polyester, benzocyclobutene (BCB), polymethylmethacrylate (PMMA), poly(4-vinylphenol) (PVP), polyvinyl alcohol (PVA), polytetrafluoroethene (PTFE), or other suitable organic insulating material), or other suitable insulating material, but not limited thereto.

The LCD panel 1 of the present embodiment may further include a first common electrode CE1, a second common electrode CE2, a second protective layer BP2 and a pixel electrode PE disposed on the first substrate 11. In present embodiment, the first common electrode CE1 and the second common electrode CE2 are different patterned conductive layers. The first common electrode CE1 is disposed in the first display region T and disposed above the planarization layer PL. The first common electrode CE1 is a transparent electrode, which may be a single-layered or multi-layered structure, and the material of the common electrode CE1 includes a transparent conductive material such as indium tin oxide (ITO), indium zinc oxide (IZO), aluminum zinc oxide(AZO), aluminum indium oxide(AIO), Indium oxide (InO), gallium oxide (GaO), carbon nanotubes, nano silver particles, metal or alloy with thickness of less than 60 nanometer (nm), an organic transparent conductive material, or other suitable transparent conductive material. The second common electrode CE2 is disposed in the second display region R and disposed above the planarization layer PL. The common electrode CE2 of the present embodiment is a reflective layer, which may be a single-layered or multi-layered structure, and the material of the second common electrode CE2 includes a reflective conductive material such as metal, wherein the metal may include Al (aluminum), Pt (platinum), Ag (silver), Ti (titanium), Mo (molybdenum), Zn (zinc), Sn (tin), Cr (chromium) or its alloys, but not limited thereto. In addition, the second common electrode CE2 can be optionally covered with a transparent electrode in order to avoid oxidation or corrosion of the metal material of the second common electrode CE2. The second protective layer BP2 covers the first common electrode CE1 and the second common electrode CE2. The material of the second protective layer BP2 may be the same as or different from the first protective layer BP1, which is not redundantly described. The pixel electrode PE is disposed on the second protective layer BP2, and the material of the pixel electrodes PE and the first common electrode CE1 could be the same or different, which is not redundantly described. In the present embodiment, the liquid crystal displaypanel 1 is a Fringe Field Switching (FFS) liquid crystal display panel, and the pixel electrode PE may be a patterned electrode, which has slits or openings, and the first common electrode CE1 and the second common electrode CE2 are full-surfaced electrodes, but not limited thereto. In this embodiment, the second common electrode CE2 of the reflective sub-pixel 221 is used as a reflective layer, but not limited thereto. For example, the second common electrode CE2 of the reflective sub-pixels 221 can also be a transparent electrode, whereas the pixel electrode PE of the reflective sub-pixel 221 can be made of reflective conductive material and used as a reflective layer. Alternatively, the pixel electrode PE and the second common electrode CE2 of the reflective sub-pixel 221 may be both transparent electrodes and an extra reflective layer (such as a metal layer) maybe disposed for reflecting ambient light.

In the present embodiment, a bottom gate type TFT device is selected as an example, but not limited thereto. The first TFT devices T1 and the second TFT devices T2 may also be top gate type, dual-gate type or other types of TFT devices. In addition, the LCD panel 1 is not limited to an FFS LCD panel. For example, the LCD panel 1 of the present embodiment may also be a Vertical Alignment (VA) LCD panel, an Electrically Controlled Birefringence (ECB) LCD panel, or other types of LCD panels.

As shown in FIG. 4, the LCD panel 1 of the present embodiment may further include a color filter layer CF disposed on the second substrate 12, for displaying color images. The color filter layer CF can include different filter layers, such as a red filter layer, a green filter layer and a blue filter layer disposed at different sub-pixels respectively. In the present embodiment, the color filter layer CF can be disposed only in the first display region T, such that the first pixel array 21 (transmissive pixel array) is able to provide color images, and the color filter layer CF is not disposed in the second display region R, so as to increase the reflectivity of the second pixel array 22 (reflective pixel array). In other words, the color filter layer CF of the present embodiment is disposed corresponding to the first transmissive sub-pixels 211 of the first pixel array 21, and the color filter layer CF is not disposed corresponding to the reflective sub-pixels 221 of the second pixel array 22. In an alternative embodiment, the color filter layer CF may be disposed in both the first display region T and the second display region R. Alternatively, when the LCD panel 1 is used as a black and white display panel, there is no need to dispose a color filter in the first display region T and the second display region R. In addition, a first overcoat layer OC1 is disposed between the liquid crystal layer LC and the color filter layer CF to separate the color filter layer CF from the liquid crystal layer LC to avoid contamination. The first overcoat layer OC1 can also protect the color filter layer CF from being scratched. Furthermore, a second overcoat layer OC2 may be disposed on the second substrate 12 corresponding to the second display region R, e.g. the second overcoat layer OC2 maybe disposed between the second substrate 12 and the first overcoat layer OC1, to adjust the cell gap of the LCD panel 1 and enhance display quality. Specifically, the second overcoat layer OC2 is disposed in the reflective sub-pixel 221 to form a dual gap structure in the LCD panel 1, which is able to adjust the optical path difference between the reflective sub-pixel 221 and the first transmissive sub-pixel 211 so that the optical path of reflective light in reflective region and the optical path of transmissive light in transmissive region are approximately the same. Consequently, the optical performance of the transmissive region and the reflective region is optimized. In general, the cell gap in the second display region R (reflective display region) is approximately ½ of the cell gap in the first display region T (transmissive display region), but not limited thereto.

The liquid crystal display panel is not limited by the aforementioned embodiment, and may have other different preferred embodiments. To simplify the description, the identical components in each of the following embodiments are marked with identical symbols. For making it easier to compare the differences between the embodiments, the following description will detail the dissimilarities among different embodiments and the identical features will not be redundantly described.

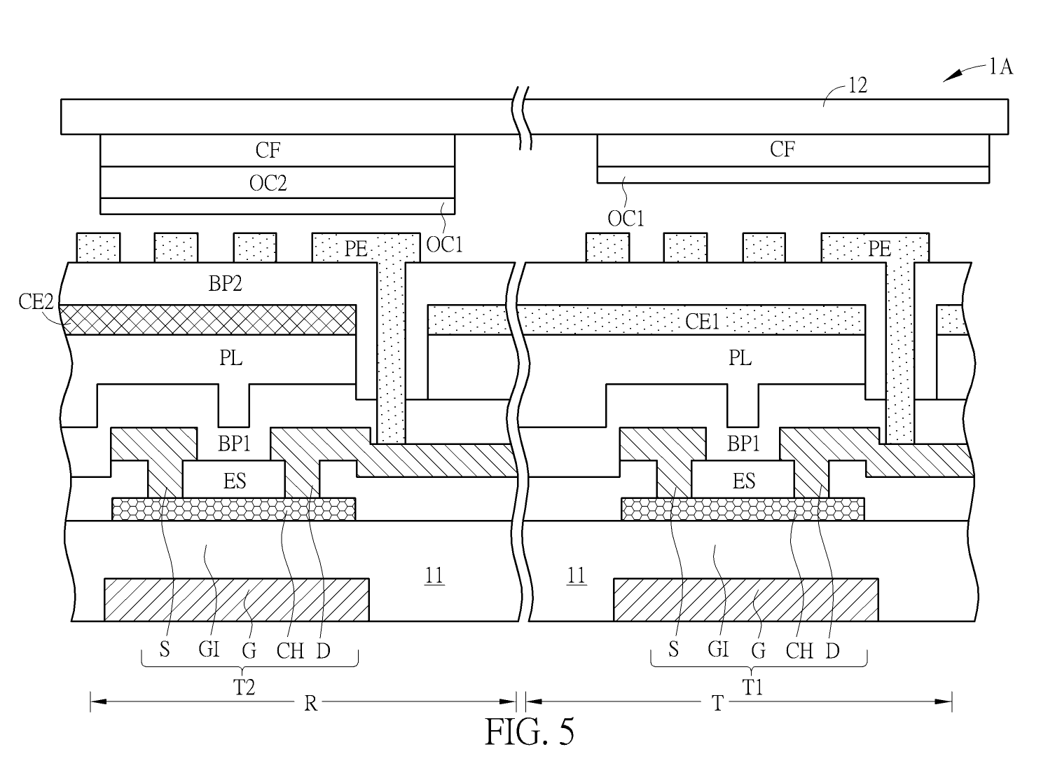

Referring to FIG. 5, FIG. 5 is a partially enlarged cross-sectional view schematic diagram illustrating an LCD panel according to an alternative embodiment of the first embodiment of the present disclosure. As shown in FIG. 5, in the LCD panel 1A of this alternative embodiment, the color filter CF is disposed in both the first display region T and the second display region R, that is, the color filter CF is disposed corresponding to the first transmissive sub-pixels 211 in the first pixel array 21, and the reflective sub-pixels 221 in the second pixel array 22.

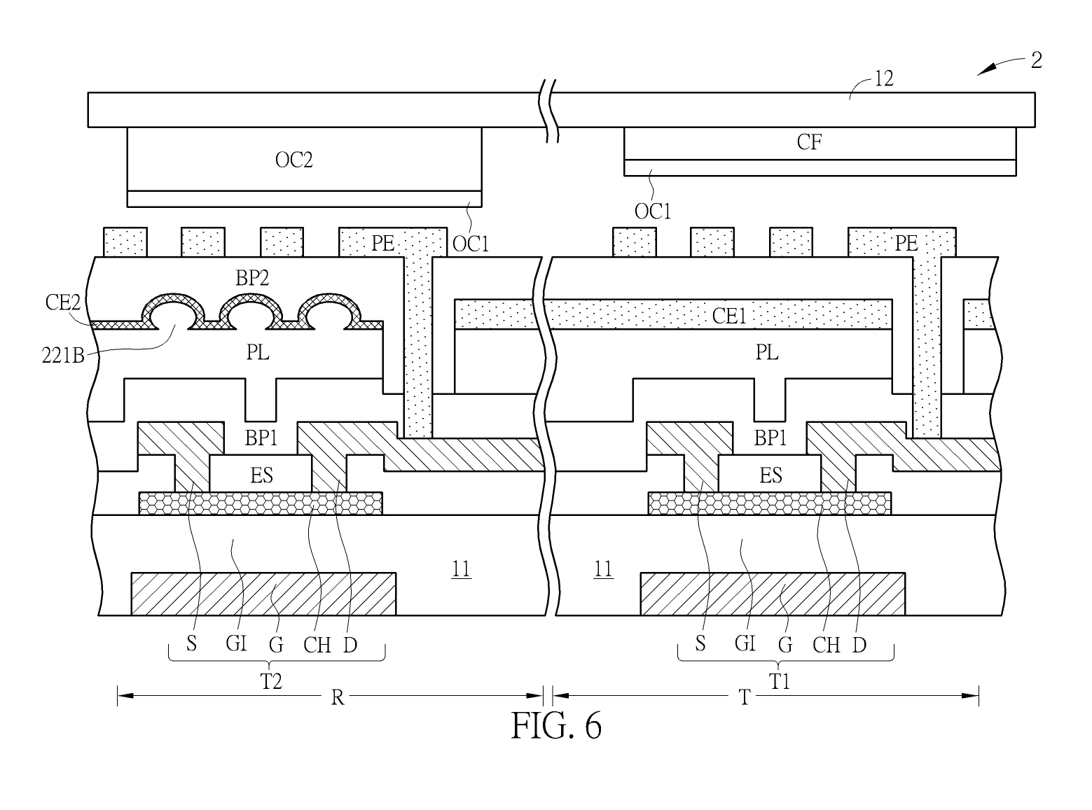

Referring to FIG. 6 and also referring FIGS. 1-3, FIG. 6 is a partially enlarged cross-sectional view diagram illustrating a LCD panel according to a second embodiment of the present disclosure. As shown in FIG. 6, in the LCD panel 2 of the present embodiment, each of the reflective sub-pixels 221 of the second display region R further includes a bump structure 221B disposed under the reflective layer (e.g. the second common electrode CE2), so that the reflective layer have a textured surface. In the present embodiment, the bump structure 221B maybe part of the planarization layer PL, or the bump structure 221B maybe additionally formed on the planarization layer PL. By disposing the bump structure 221B, the reflective layer e.g. the common electrode CE2 disposed above the bump structure 221B will have a textured surface, thereby increasing the reflective performance.

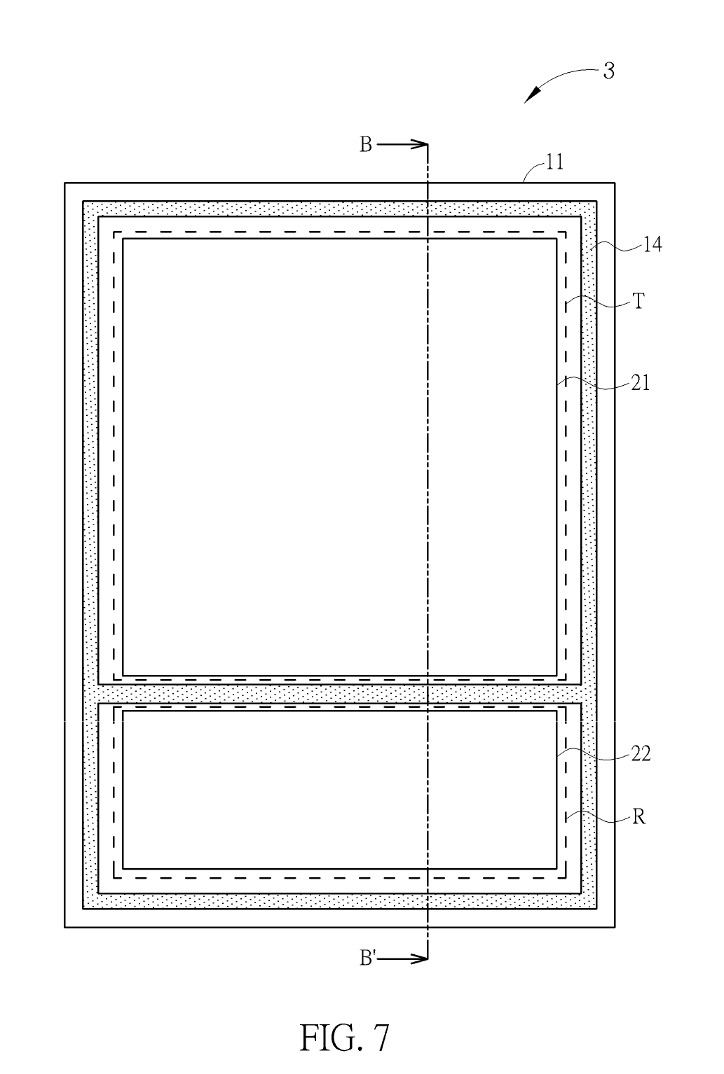

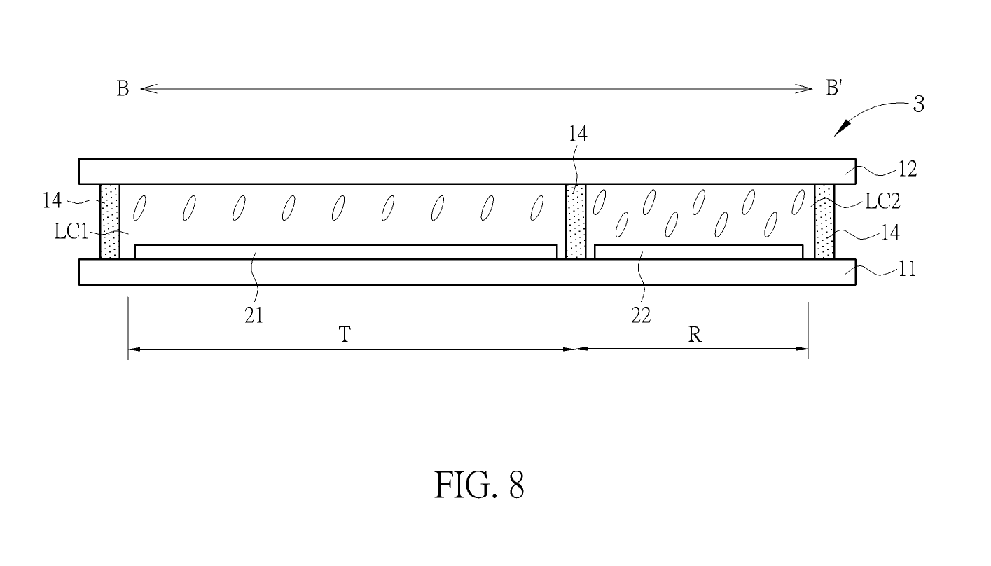

Please refer to FIG. 7 and FIG. 8. FIG. 7 and FIG. 8 are schematic diagrams illustrating an LCD panel according to a third embodiment of the present disclosure, where FIG. 7 is a top view diagram illustrating an LCD panel according to a third embodiment of the present disclosure, and FIG. 8 is a cross-sectional view diagram of the LCD panel taken along line B-B′ of FIG. 7. As shown in FIGS. 7-8, different from the first embodiment, the LCD panel 3 of the present embodiment includes a first liquid crystal layer LC1 and a second liquid crystal layer LC2, wherein the first liquid crystal layer LC1 is located in the first display region T, and the second liquid crystal layer LC2 is located in the second display region R. The material of the first liquid crystal layer LC1 and the material of the second liquid crystal layer LC2 are different, and the first liquid crystal layer LC1 and the second liquid crystal layer LC2 are separated by the sealant 14. Specifically, in addition to surrounding the first display region T and the second display region R, the sealant 14 is further disposed between the first display region T and second display region R to separate the first liquid crystal LC1 from the second liquid crystal layer LC2. Since the display requirement in the transmissive display and the reflective display are different, to dispose the first liquid crystal LC1 in the first region T and to dispose the second liquid crystal in the second region R can obtain better display quality. In the LCD panel 3 of this present embodiment, the first pixel array 21 is a Fringe Field Switching (FFS) mode pixel array, and the second pixel array 22 is a Vertical Alignment (VA) pixel array. Alternatively, the first pixel array 21 may be a Fringe Field Switching mode pixel array, and the second pixel array 22 may be an Electrically Controlled Birefringence (ECB) pixel array, but not limited thereto. The modes of the first pixel array 21 served as a transmissive pixel array and the second pixel array 22 served as a reflective pixel array can be modified depending on the requirement of display.

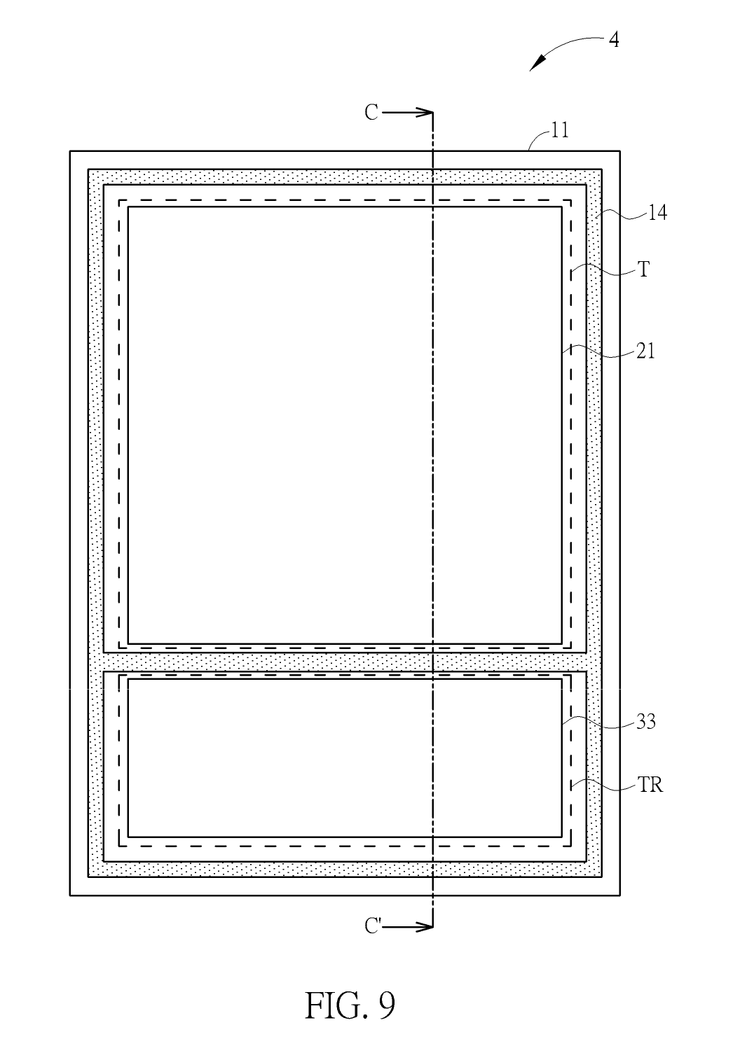

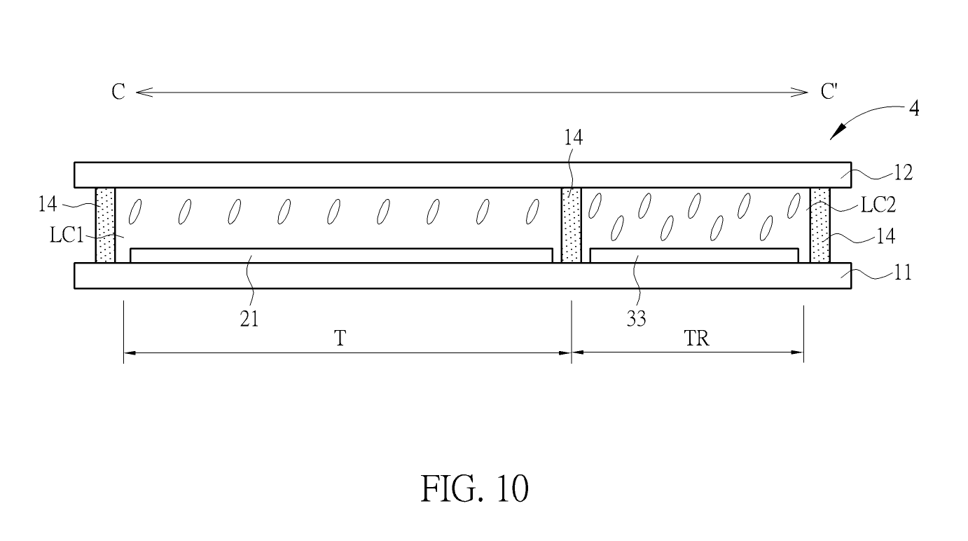

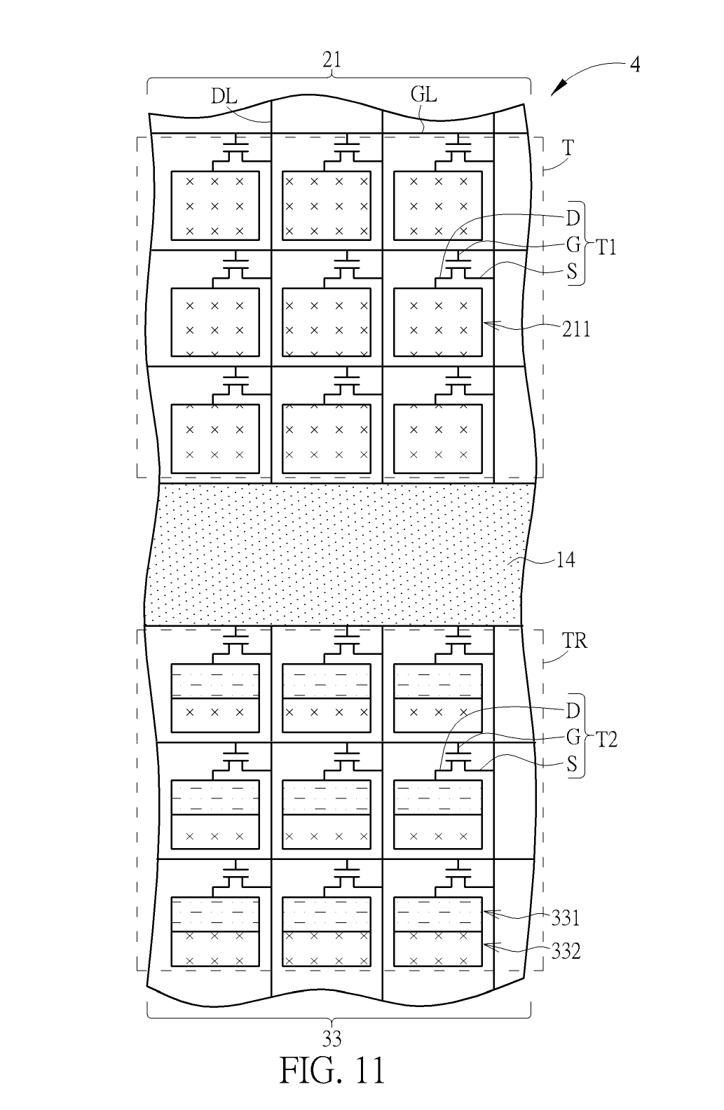

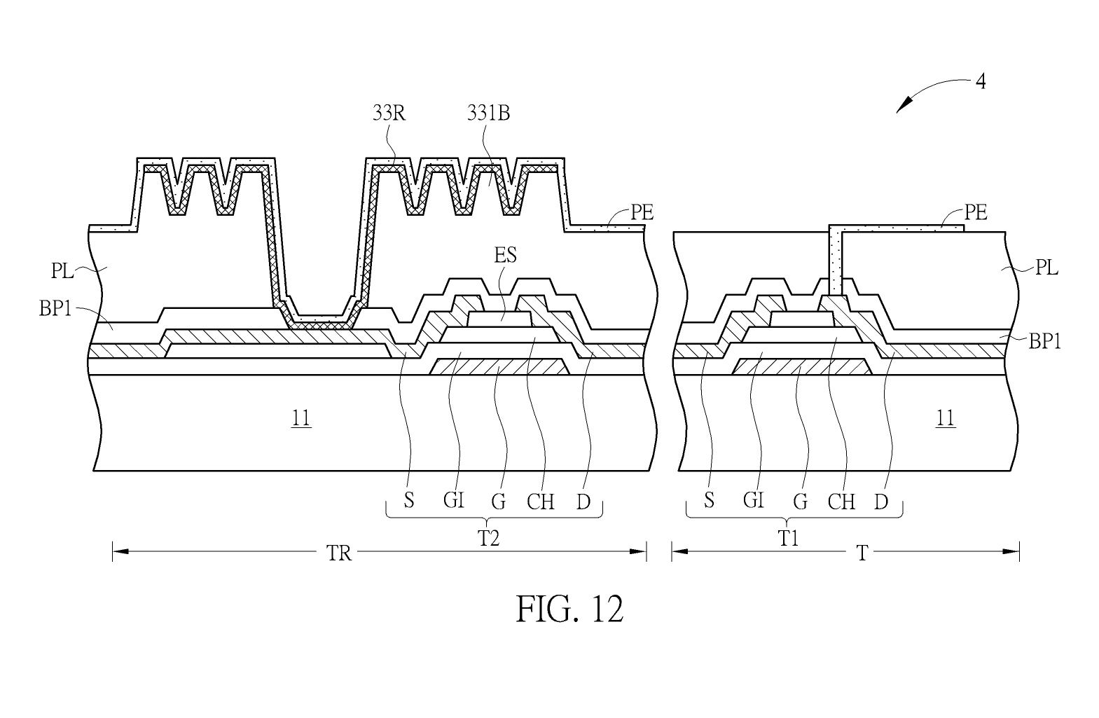

Please refer to FIGS. 9-12. FIGS. 9-12 are schematic diagrams illustrating an LCD panel according to a fourth embodiment of the present disclosure, where FIG. 9 is a top view diagram illustrating an LCD panel, FIG. 10 is a cross-sectional view diagram of the LCD panel taken along line C-C′of FIG. 9, FIG. 11 is a partially enlarged top view diagram illustrating the LCD panel of FIG. 9, and FIG. 12 is a partially enlarged cross-sectional view diagram illustrating the LCD panel. As shown from FIGS. 9-12, the first display region T of the LCD panel 4 of the present embodiment and that of the aforementioned embodiment are both transmissive display region, which includes a plurality of first transmissive sub-pixels 211 arranged in columns and rows, and the plurality of first transmissive sub-pixels 211 are disposed adjacent to each other. Different from the aforementioned embodiments, the second display region TR of this embodiment is a transflective display region. That is, the second pixel array 33 disposed in the second display region TR not only includes the reflective sub-pixels 331 but also includes a plurality of second transmissive sub-pixels 332 arranged in columns and rows, where the reflective sub-pixels 331 and the second transmissive sub-pixels 332 are disposed adjacent to each other and arranged alternately. For example, the reflective sub-pixels 331 and the second transmissive sub-pixel 332 are disposed adjacent to each other and arranged alternately in the column direction, but not limited thereto. The reflective sub-pixels 331 and the second transmissive sub-pixel 332 may be disposed adjacent to each other and arranged alternately in the row direction or arranged in another alternate configuration. In the present embodiment, one of the second transmissive sub-pixels 332 and one of the reflective sub-pixels 331 in the second display region TR disposed adjacent to each other may connect to the same second TFT device T2. To be exact, the pixel electrode PE of the second transmissive sub-pixels 332 and that of the reflective sub-pixels 331 are connected to each other and connected to the same second TFT device T2. In addition, as shown in FIG. 12, the reflective sub-pixels 331 further include a reflective layer 33R disposed on the planarization layer PL, for example, disposed between the planarization layer PL and the pixel electrode PE, and the bumps structure 331B is disposed between the planarization layer PL and the reflective layer 33R, such that the reflective layer 33R has textured surface to increase the reflective performance. In addition, the thickness of planarization layer PL in the reflective sub-pixels 331 may be thicker than the thickness of planarization layer PL in the transmissive sub-pixels 332 to adjust the height of the cell gap of LCD panel 4, to form a dual gap structure. In an alternative embodiment, the second transmissive sub-pixels 332 and the reflective sub-pixels 331 may be driven by different TFT devices. Further, a Vertical Alignment (VA) mode LCD panel is selected as an example of the LCD panel 4, but not limited thereto.

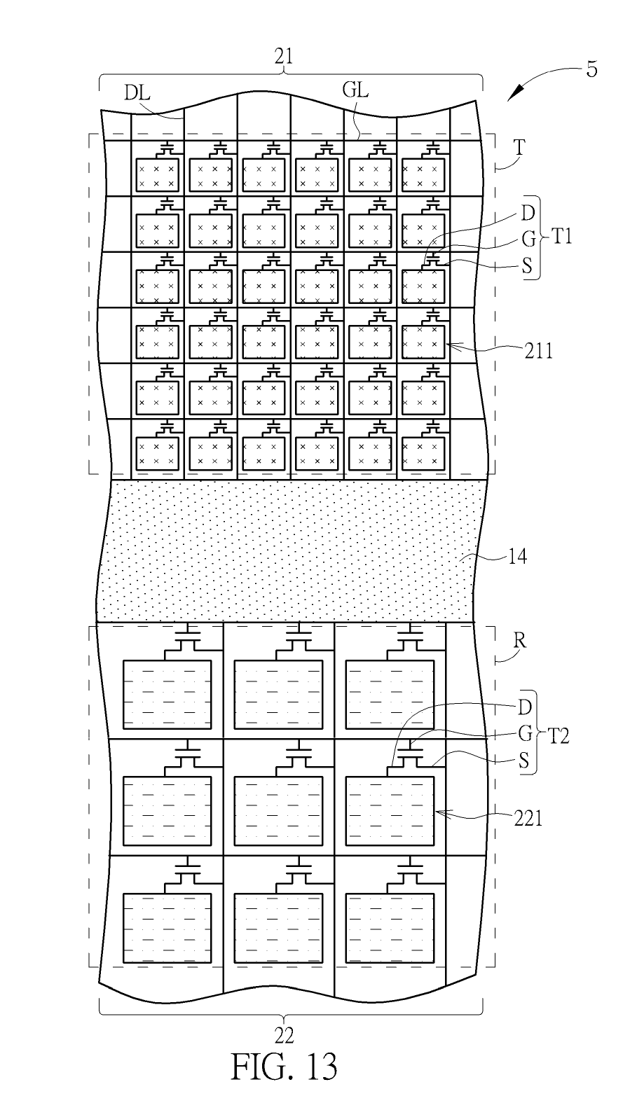

Referring to FIG. 13, FIG. 13 is a partially enlarged top view diagram illustrating an LCD panel according to a fifth embodiment of the present disclosure. As shown in FIG. 13, in the LCD panel 5 of the present embodiment, the resolution of the first pixel array 21 and the resolution of the second pixel array 22 are different. For example, when the LCD panel 5 is applied to a smart watch, the first display region T is transmissive display region, which can be used to display images, video, or application software information, and the second display region R is reflective display region, which can be used to display time, weather, or other information in the outdoor environment. Under this condition, the resolution of the first pixel array 21 may be higher than the resolution of the second pixel array 22 in order to achieve better display performance. In addition, the pixel size of the first transmissive sub-pixel 211 of the first pixel array 21 and that of the reflective sub-pixels 221 of the second pixel array 22 are different. For example, the pixel size of the transmissive sub-pixel 211 of the first pixel array 21 is smaller than the pixel size of the reflective sub-pixel 221 of the second pixel array 22, but not limited thereto. In the present embodiment, a sealant 14 is disposed between the first display region T and the second display region R to separate the first liquid crystal LC1 (as shown in FIG. 8) from the second liquid crystal LC2 (as shown in FIG. 8), but not limited thereto. Alternatively, when the same liquid crystal layer is used, no sealant is required to be disposed between the first display region T and the second display region R. In an alternative embodiment, the first display region may be a transmissive region and the second display region may be a transflective region.

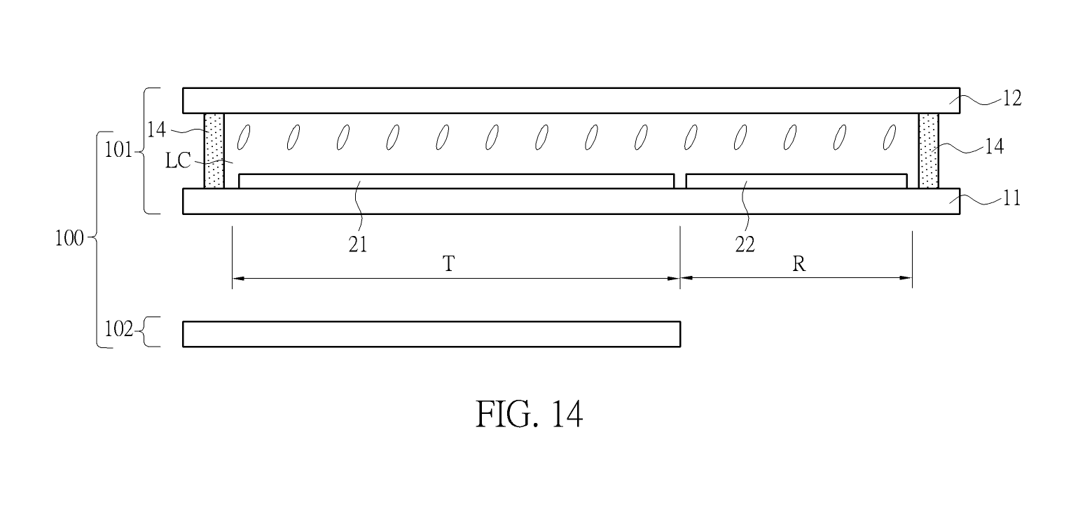

The above-described embodiment discloses several alternative embodiments of LCD panels of the present disclosure, and the LCD panel of the present disclosure may further be combined with a backlight module to be an LCD device. Please refer to FIG. 14. FIG. 14 is a schematic diagram illustrating an LCD device according to an embodiment of the present disclosure. As shown in FIG. 14, the LCD device 100 of this embodiment includes an LCD panel 101 and a backlight module 102. The LCD panel 101 could be selected from the LCD panels of the above embodiments in which the second display region is a reflective display region. The backlight module 102 is disposed under the LCD panel 101. In the present embodiment, the backlight module 102 can be disposed only under the bottom of the first display region T, whereby in indoor environment or when ambient light is insufficient, the backlight emitted by the backlight module 102 is able to provide backlight source for the first display region T (transmissive display region) for displaying image, text or video and other information. In outdoor environment or when ambient light is sufficient, the second display region R (reflective display region) do not need backlight and can use ambient light to display information to save power. Further, since the second display region R is not equipped with the backlight module 102, the spare space of the second display region R can also be used to accommodate other components of an LCD device.

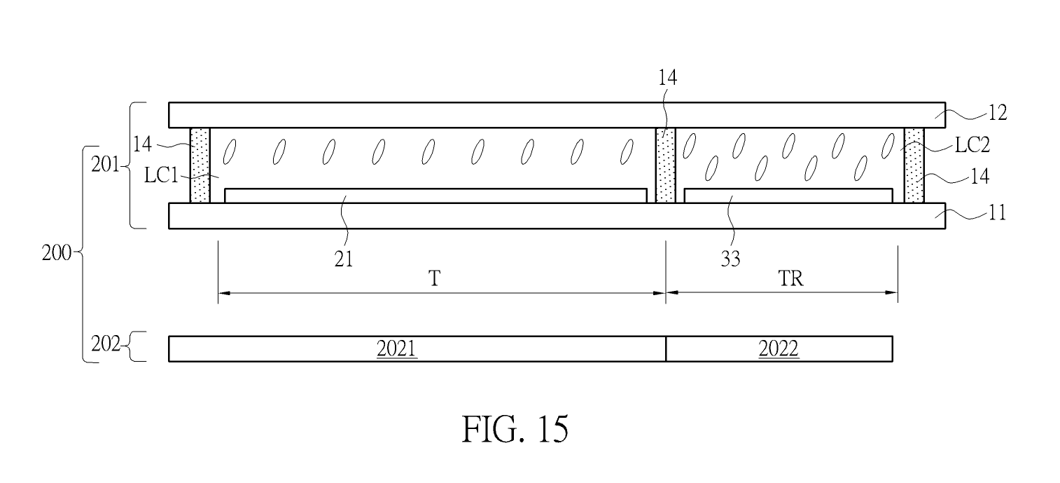

Please refer to FIG. 15. FIG. 15 is a schematic diagram illustrating an LCD device according to another embodiment of the present disclosure. As shown in FIG. 15, the LCD device 200 of this embodiment includes an LCD panel 201 and a backlight 202. The LCD panel 201 could be selected from the LCD panels of the above embodiments in which the second display region is a transflective display region. In this embodiment, the backlight module 202 includes a first backlight portion 2021 and a second backlight portion 2022, where the first backlight portion 2021 is disposed corresponding to the first display region T, the second backlight portion 2022 is disposed corresponding to the second display region TR, and the first backlight portion 2021 and the second backlight portion 2022 are controlled separately. Consequently, the backlight of the first display region T and the backlight of the second display region TR can be independently controlled, and thus power consumption of the backlight module 202 can be reduced.

In summary, the LCD panel and the LCD device of the present disclosure include a transmissive display array and a reflective display array (or a transflective display array), which can be selectively provided under different environments. For example, the LCD panel and the LCD device of the present disclosure can be applied to smart watches or other portable electronic products, in which the transmissive display array may be a high-resolution display array for displaying pictures, movies or software in high resolution in indoor environment or when lack of ambient light; the reflective display region and the transflective display region array may be a low-resolution display region for displaying time, temperature, weather or other information in outdoor activities. The LCD panel and the LCD device can not only meet the needs of different environments, but can also effectively save power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD) panel, comprising:
a first substrate;
a second substrate;
at least one liquid crystal layer interposed between the first substrate and the second substrate;
a first pixel array disposed in a first display region of the first substrate, wherein the first pixel array comprises a plurality of first transmissive sub-pixels arranged in columns and rows and disposed adjacent to each other; and
a second pixel array disposed in a second display region of the first substrate, wherein the second pixel array comprises a plurality of reflective sub-pixels arranged in columns and rows.

2. The LCD panel of claim 1, wherein the plurality of the reflective sub-pixels arranged in columns and rows are disposed adjacent to each other.

3. The LCD panel of claim 1, wherein the second pixel array further comprises a plurality of second transmissive sub-pixels arranged in a plurality of rows and a plurality of columns, and the reflective sub-pixels and the second transmissive sub-pixels are disposed adjacent to each other and arranged alternately.

4. The LCD panel of claim 1, further comprising a first common electrode and a second common electrode disposed in the first display region and the second display region of the first substrate, respectively, wherein the first common electrode and the second common electrode are different patterned conductive layers.

5. The LCD panel of claim 1, further comprising a sealant disposed between the first substrate and the second substrate and surrounding the first display region and the second display region.

6. The LCD panel of claim 5, wherein the at least one liquid crystal layer comprises a first liquid crystal layer located in the first display region, and a second liquid crystal layer located in the second display region, wherein a material of the first liquid crystal layer and a material of the second liquid crystal layer are different, and the first liquid crystal layer and the second liquid crystal layer are separated by the sealant.

7. The LCD panel of claim 6, wherein the first pixel array is a Fringe Field Switching (FFS) mode pixel array and the second pixel array is a Vertical Alignment (VA) mode pixel array.

8. The LCD panel of claim 6, wherein the first pixel array is a Fringe Field Switching mode pixel array, and the second pixel array is an Electrically Controlled Birefringence (ECB) mode pixel array.

9. The LCD panel of claim 1, wherein a portion of the first transmissive sub-pixels and a portion of the reflective sub-pixels located in the same row or in the same column use a same signal line jointly.

10. The LCD panel of claim 9, wherein the single line comprises a data line.

11. The LCD panel of claim 1, wherein a resolution of the first pixel array and that of the second pixel array are different.

12. The LCD panel of claim 11, wherein the resolution of the first pixel array is higher than the resolution of the second pixel array.

13. The LCD panel of claim 1, wherein a pixel size of the first transmissive sub-pixel of the first pixel array and a pixel size of the reflective sub-pixel of the second pixel array are different.

14. The LCD panel of claim 13, wherein the pixel size of the first transmissive sub-pixel of the first pixel array is smaller than the pixel size of the reflective sub-pixel of the second pixel array.

15. The LCD panel of claim 1, wherein
each of the first transmissive sub-pixels comprises a first thin film transistor device, and the first thin film transistor device comprises a gate electrode, a source electrode and a drain electrode;
each of the reflective sub-pixels comprises a second thin film transistor device, and the second thin film transistor device comprises a gate electrode, a source electrode and a drain electrode; and
wherein the gate electrode of the first thin film transistor device and the gate electrode of the second thin film transistor device are a same patterned conductive layer, and the source electrode and the drain electrode of the first thin film transistor device and the source electrode and the drain electrode of the second thin film transistor device are a same patterned conductive layer.

16. The LCD panel of claim 1, wherein each of the reflective sub-pixels comprises a reflective layer.

17. The LCD panel of claim 16, wherein each of the reflective sub-pixels further comprises a bump structure disposed under the reflective layer so that the reflective layer have a textured surface.

18. The LCD panel of claim 1, further comprising a color filter layer disposed on the second substrate, wherein the color filter layer is disposed corresponding to the first transmissive sub-pixels of the first pixel array, and the color filter layer is not disposed corresponding to the reflective sub-pixels of the second pixel array.

19. The LCD panel of claim 1, further comprising a color filter layer disposed on the second substrate, wherein the color filter layer is disposed corresponding to the first transmissive sub-pixels of the first pixel array, and the reflective sub-pixels of the second pixel array.

20. A liquid crystal display (LCD) device, comprising:
the LCD panel of claim 1; and
a backlight module disposed under the LCD panel.

21. The LCD device of claim 20, wherein the backlight module is disposed only under the first display region.

22. The LCD device of claim 20, wherein the backlight module comprises a first backlight portion and a second backlight portion, the first backlight portion is corresponding to the first display region, the second backlight portion is corresponding to the second display region, and the first backlight portion and the second backlight portion are controlled independently.
